(19) United States
(12) Patent Application Publication
(10) Pub. No.: US 2013/0073233 A1
(43) Pub. Date: Mar. 21, 2013

(54) Detection of Low Voltage Electrolysis in a Battery Pack

(71) Applicants: Francisco LePort, San Francisco, CA (US); Weston Arthur Hermann, Palo Alto, CA (US)

(72) Inventors: Francisco LePort, San Francisco, CA (US); Weston Arthur Hermann, Palo Alto, CA (US)

(73) Assignee: TESLA MOTORS, INC., Palo Alto, CA (US)

(21) Appl. No.: 13/239,235

(22) Filed: Sep. 21, 2011

(51) Int. Cl. G06F 19/00

(52) U.S. Cl. 702/63

(57) ABSTRACT

An apparatus and method providing for detecting and responding to low voltage electrolysis within an electric vehicle battery detecting and responding to low voltage electrolysis within an electric vehicle battery enclosure to limit a possible hazard condition of battery enclosure. The present invention includes embodiments directed towards detection algorithms and apparatus for promoting the use of sensors (e.g., hydrogen, voltage, current, and immersion sensors) for the purpose of detecting low voltage electrolysis. Additionally, the present invention includes response processes and structures to address low voltage electrolysis.

### CROSS REFERENCE TO RELATED APPLICATIONS

This application is related to U.S. patent application Ser. No. 12/942,465 filed Nov. 9, 2010 and titled “FILL PORT FOR ELECTRIC VEHICLE BATTERY ENCLOSURE,” U.S. patent application Ser. No. 12/942,501 filed Nov. 9, 2010 and titled “PERFORATION APPARATUS AND METHOD FOR ELECTRIC VEHICLE BATTERY ENCLOSURE,” Attorney Docket Number 20109-7057 (U.S. application Ser. No. ______ co-filed with the present application and titled “DETECTION OF HIGH VOLTAGE ELECTROLYSIS OF COOLANT IN A BATTERY PACK,” Attorney Docket Number 20109-7058 (U.S. application Ser. No.: ______ co-filed with the present application and titled “RESPONSE TO LOW VOLTAGE ELECTROLYSIS IN A BATTERY PACK,” and Attorney Docket Number 20109-7059 (U.S. application Ser. No. ______ co-filed with the present application and titled “RESPONSE TO HIGH VOLTAGE ELECTROLYSIS OF COOLANT IN A BATTERY PACK,” all the disclosures of which are hereby expressly incorporated by reference thereto in their entireties for all purposes.

### BACKGROUND OF THE INVENTION

The present invention relates generally to detection and remediation of potentially hazardous conditions in an electric vehicle battery enclosure, and more particularly but not exclusively, to detecting and responding to low voltage electrolysis within the battery enclosure to limit any possible explosive hazard of hydrogen gas concentration buildup.

Battery packs used with electric vehicles store large amounts of energy in a small space, producing high energy densities. These battery packs include an external housing that is designed for more than just environmental protection and packaging efficiency. The housing also enhances safety and stability, particularly under a range of anticipated abnormal operating conditions.

Battery pack designs include an integrated and isolated cooling system that routes coolant throughout the enclosure. When in good working order, the coolant from the cooling system does not come into contact with the electric potentials protected within. It does happen that sometimes a leak occurs and coolant enters into unintended parts of the enclosure. In certain situations, the coolant may be electrically conductive and can bridge terminals having differing potentials of a few volts. That bridging may start a low voltage electrolysis process in which the coolant is electrolyzed and the coolant will begin to generate hydrogen gas within the enclosure. This hydrogen gas can buildup and pose a possible hazard at concentrations of as little as 3% by volume in air.

What is needed is an apparatus and method for detecting and responding to low voltage electrolysis within an electric vehicle battery enclosure to limit a possible hazard condition of battery enclosure.

### BRIEF SUMMARY OF THE INVENTION

Disclosed is an apparatus and method providing for detecting and responding to low voltage electrolysis within an electric vehicle battery detecting and responding to low voltage electrolysis within an electric vehicle battery enclosure to limit a possible hazard condition of battery enclosure. The present invention includes embodiments directed towards detection algorithms and apparatus for promoting the use of sensors (e.g., hydrogen, voltage, current, and immersion sensors) for the purpose of detecting low voltage electrolysis. Additionally, the present invention includes response processes and structures to address low voltage electrolysis.

Regarding detection, a detection system for low voltage electrolysis in a battery pack, includes an enclosure including a plurality of electrically-coupled battery modules storing energy for the battery pack and a coolant distribution system disposed among and electrically isolated from the plurality of battery modules; a sensor system, coupled to the enclosure, configured to collect a plurality of data from the enclosure; and a controller, coupled to the sensor system, configured to evaluate the plurality of data against one or more predetermined patterns associated with a possible low voltage electrolysis inside the enclosure, with the controller configured to indicate the possible low voltage electrolysis occurring within the enclosure when the plurality of data has a predetermined relationship to the one or more predetermined patterns; wherein the coolant distribution system uses a coolant solution that releases hydrogen gas when electrolyzed using a voltage potential of about 5 volts or more.

A method for detecting a low voltage electrolysis in a battery pack includes a) collecting a plurality of data from a sensor system measuring data from an enclosure, the enclosure including a plurality of electrically-coupled battery modules storing energy for the battery pack and a coolant distribution system disposed among and electrically isolated from the plurality of battery modules; b) evaluating, using a controller, the plurality of data against one or more predetermined patterns associated with a possible low voltage electrolysis inside the enclosure, with the controller indicating the possible low voltage electrolysis occurring within the enclosure when the plurality of data has a predetermined relationship to the one or more predetermined patterns; wherein the coolant distribution system uses a coolant solution that releases hydrogen gas when electrolyzed using a voltage potential of about 5 volts or more.

Regarding responding to a detected low voltage electrolysis, a microprocessor-implemented response system for low voltage electrolysis in a battery pack, includes an evaluator to monitor, using the microprocessor, a low voltage electrolysis flag indicative of a possible low voltage electrolysis within an enclosure including a plurality of electrically-coupled battery modules storing energy for the battery pack and a coolant distribution system disposed among and electrically isolated from the plurality of battery modules; and a remediation system, coupled to the enclosure and responsive to the possible low voltage electrolysis when the evaluator detects a likelihood of the possible low voltage electrolysis, to decrease risks associated with the possible low voltage electrolysis when the remediation system is active.

A method for responding to a low voltage electrolysis in a battery pack includes: a) monitoring, using a microprocessor, a low voltage electrolysis flag indicative of a possible low voltage electrolysis within an enclosure including both a plurality of electrically-coupled battery modules storing energy for the battery pack and a coolant distribution system disposed among and electrically isolated from the plurality of battery modules; and thereafter b) activating a remediation system, coupled to the enclosure and responsive to the possible low voltage electrolysis when the monitoring detects a likelihood of the possible low voltage electrolysis, to decrease risks associated with the possible low voltage electrolysis.

One of the important considerations about the preferred embodiments is that many fluids in addition to coolant from a leak present the same risk. For ingress or accumulation of any conductive fluid (e.g., coolant, condensation and/or external/salty water) in the enclosure in sufficient volume that electrolysis (particularly low voltage electrolysis from a potential difference of a few volts) produces hydrogen gas, there is a risk of accumulation of hydrogen gas to potentially hazardous levels. For purposes of the present invention, “low” for “low voltage” electrolysis contemplates a voltage potential and associated current just sufficient to initiate hydrogen-generating electrolysis of fluid within the enclosure and the particular value depends upon the material being electrolyzed. The value is most often five volts or less where hydrogen gas begins to be generated.

The related and incorporated patent applications identify high voltage electrolysis (HVE) of coolant. While those applications are directed to different detection mechanisms, risks, and responses, high voltage electrolysis also generates hydrogen gas. However, the HVE of coolant poses different and potentially greater risks requiring different levels of urgency. For purposes of distinction, high voltage electrolysis of a fluid in general, coolant specifically, and 50/50 ethylene glycol/water solution most specifically, occurs at a voltage dependent upon the material. For the glycol/water solution referenced herein, HVE begins in the range of about 100-150 Volts. While hydrogen is being generated, the risks associated with HVE become more urgent as described in the incorporated co-pending applications. Because of the greater risks, the urgency is first to distinguish between HVE and LVE, and for HVE, to elevate the urgency of the response. Response to HVE should be performed as quickly as it is safe to do, with safety informed by preventing/delaying some of the potential risks associated with HVE. LVE may occur over many hours or days without major risk.

The preferred embodiments include process and apparatus that are useful to detect a low voltage electrolysis reaction and include one or more of: a hydrogen sensor placed within the enclosure; real-time analysis of series element voltage values and histories; current sensor data from a central location in the series chain or multiple locations in addition to a current sensor at one or both terminals; real-time analysis of coolant flow rates, into and out of the battery pack; and an immersion sensor placed within the enclosure.

The preferred embodiments include process and apparatus that are useful to respond to a low voltage electrolysis reaction: once a coolant leak is detected, the coolant pumping system can be deactivated, to minimize additional coolant from leaking into the pack; detection of hydrogen gas could initiate an active purging of potentially flammable gas out of the enclosure using a valve and fan; and detection of possible low voltage hydrolysis could add an inert gas (e.g., nitrogen) into the enclosure to displace oxygen.

Also included are process and apparatus for safely handling an enclosure once a vehicle is brought in for service, including provision and use of purge inlet and outlet ports to add inert gas and route possibly hydrogen and/or oxygen-rich exhaust gas before opening the enclosure for service. The hydrogen concentration of the exhaust is monitored until the concentration is deemed low enough to open safely (e.g., a hydrogen concentration of less than 0.5% by volume).

Features/benefits include an ability to detect a low voltage electrolysis and/or remediate conditions or consequences of such a low voltage electrolysis to limit a possibility of buildup of hydrogen gas inside a battery enclosure for a high energy battery pack, such as the type used in electric vehicles and similar applications.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a system of an electric vehicle that includes a propulsion battery that is cooled using a coolant recirculating through an enclosure that houses individual battery modules of the propulsion battery;

FIG. 2 illustrates a flow diagram for a detection process;

FIG. 3 illustrates a flow diagram for a remediation response process; and

FIG. 4 illustrates a purge system for displacement of oxygen within a battery pack enclosure.

### DETAILED DESCRIPTION OF THE INVENTION

Embodiments of the present invention provide an apparatus and method providing for detecting and responding to low voltage electrolysis within an electric vehicle battery enclosure to limit a possible hazard condition of battery enclosure. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the discussion herein regarding the preferred embodiments, no particular coolant distribution system or coolant mixture is contemplated to be used as many coolant fluids will release hydrogen gas upon low voltage electrolysis. More generically, the preferred embodiments are configured to detect and respond to a release of a flammable gas (e.g., hydrogen) during a low voltage (e.g., a few volts) electrolysis of any fluid, coolant or otherwise, disposed within a battery pack enclosure. While rare, coolant solution leaks from the coolant distribution system sometimes occur and provide a potential source of fluid accumulation in the enclosure. Fluid condensation and external fluid ingress are other sources of fluid inside the enclosure that can produce hydrogen gas when undergoing low voltage electrolysis.

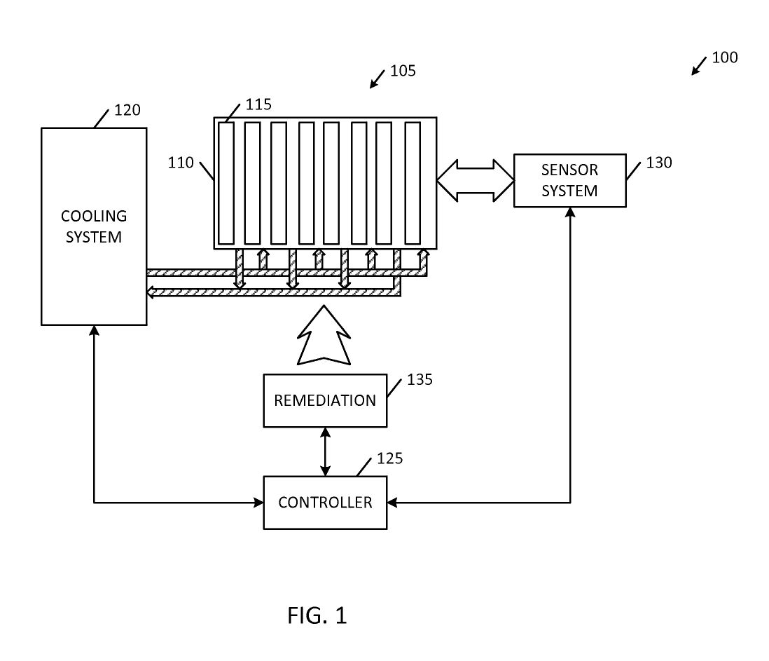

FIG. 1 illustrates a system 100 of an electric vehicle that includes a propulsion battery 105 that is cooled using a coolant recirculating through an enclosure 110 that houses a plurality of battery modules 115 of propulsion battery 105. There are many ways that a cooling system is implemented but will typically include a fluid reservoir 120. The cooling system is monitored and controlled by a controller 125. In the preferred embodiments, a particular sensing arrangement is implemented as more detailed below. One or more sensors of a sensor system 130 are used to monitor specifically for parameters indicating that the low voltage electrolysis is occurring or that it is likely occurring.

In general, detection of a low voltage electrolysis reaction includes proper selection, placement, and implementation of the one or more sensors of sensor system 130. Controller 125 monitors sensor system 130 and applies the proper detection logic based upon the detection mechanism. Upon detection of actual or possible low voltage electrolysis, controller 125 initiates operation of a remediation system 135 to respond appropriately to the detected actual or possible low voltage electrolysis. These are two independent, though related, aspects of the present invention. The first is detection of a low voltage electrolysis event and the second is remediation of such an event. The remediation options, including those available beyond those shown and described herein, do not require detection of the low voltage electrolysis using one of the disclosed systems or processes. Similarly, detection options, including those available beyond those shown and described herein, do not require remediation of the low voltage electrolysis using one of the disclosed systems or processes.

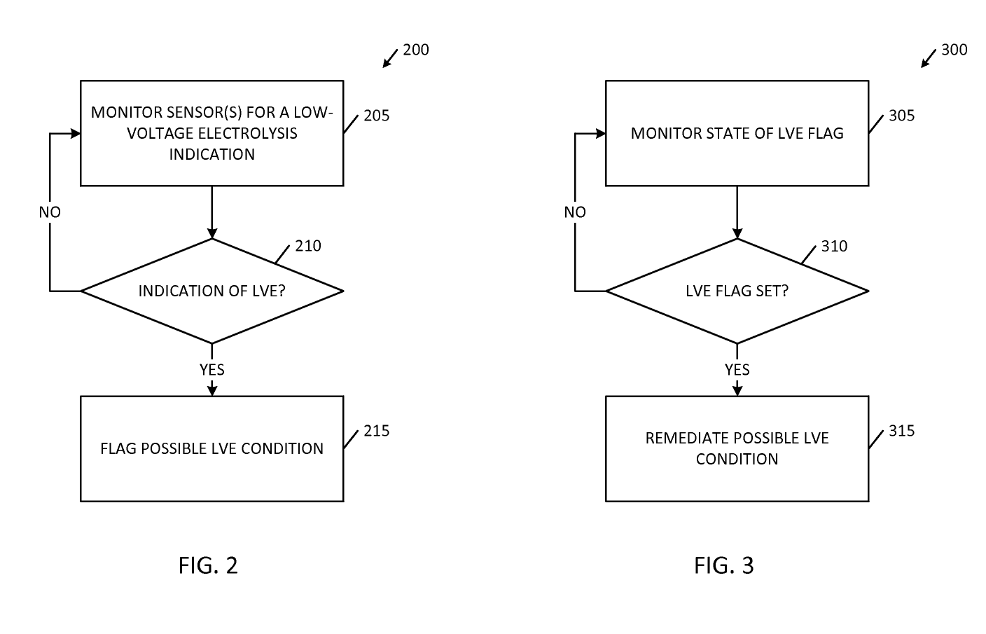

FIG. 2 and FIG. 3 further illustrate this independence and relationship. FIG. 2 illustrates a flow diagram for a detection process 200. Process 200 includes a low voltage electrolysis (LVE) monitoring step 205, an LVE test step 210, and an LVE flag step 215 when the test at step 210 is true.

Step 205 monitors one or more sensors of sensor system 130 shown in FIG. 1. The sensors are implemented to examine specific conditions, parameters, and operational characteristics of system 100 appropriate for the methodology used to detect an LVE of coolant inside a battery enclosure. An result of monitoring data from the sensors is tested at step 210 to determine whether LVE is underway. In some cases it may be an indication of likely LVE or possible LVE.

Depending upon the nature of the test and the threshold set for initiation of remediation, there may be different responses and urgency levels for initiation of the remediation. In some implementations, there are combinations of sensors providing different indications, not all of which may have the same urgency. There may also be different remediation responses appropriate for different types of sensor indications. Thus the test at step 210 may be binary type indication (e.g., YES or NO as shown), or it may indicate varying probabilities for different possible risks.

When the test at step 210 is positive to indicate existence, or possible existence, of LVE in system 100, process 200 sets a flagging mechanism or other status mechanism appropriate for the test performed at step 210. Some other system or process may monitor the flag and initiate an appropriate response. Flagging a possible LVE condition within enclosure 110 identified in step 215 refers to those general concepts of acknowledging and initiating further action. This is not limited to polling/testing a state of a data flag, but may include interrupt processing and other evaluative systems for responding to a state, variable, signal, or other “flag” that indicates an affirmative test/evaluation at step 210. The results of step 215 are made available to a response initiation process, such as the process shown in FIG. 3.

FIG. 3 illustrates a flow diagram for a response process 300. Process 300 includes a monitoring step 305, a test step 310, and a remediation initiation step 315. Step 305 includes an appropriate evaluative process for monitoring a status of an LVE flag, such as may have happened at step 215 of FIG. 2. Step 310 tests whether the LVE flag meets a predetermined pattern indicating that LVE is, or may be, occurring. The pattern may be a bit value, a threshold, or other parameter that can be used to selectively test for the LVE condition.

When the test at step 310 is affirmative that LVE is, or may be, occurring, process 300 executes step 315 to initiate remediation of the detected LVE condition. The initiation response varies but is appropriate for the detected condition and other implementation details. Further details of the sensor(s) and possible remediation response(s) are detailed below.

I. LVE Detection

Regarding specifics of representative sensors for sensor system 130. The preferred embodiments include process and apparatus that are useful to detect LVE, or possible LVE, within enclosure 110.

HYDROGEN GAS—Sensor system 130 may include one or more hydrogen gas sensors. Enclosure 110 may be hermetically sealed but will often provide for one or more one-way exhaust ports to allow gas to escape. Hydrogen gas is produced during LVE. The hydrogen gas sensors are placed inside enclosure 110, preferably at likely location(s) of LVE or hydrogen gas accumulation. Analyses of the orientation and arrangement of enclosure 110, battery modules 115, and coolant circulation paths, including possible failure modes, provides an indication of these likely locations. In some cases, the design of one or more of these systems is adapted to improve detection using hydrogen gas sensors, or to enable fewer sensors to be used.

One way that hydrogen sensors may be used to detect LVE is to monitor for a particular pattern indicative of LVE in the particular implementation. For example, should the hydrogen gas sensors detect any increase in concentration of hydrogen above zero. Other patterns may be appropriate in this or other contexts.

VOLTAGE—Sensor system 130 may include one or more voltage sensors. Battery modules 115 are coupled in series to store and produce the energy of propulsion battery 105. Additionally, it is common for the modules themselves to include series-connected batteries or other battery unit. The voltage sensors are placed in enclosure 110 to measure real-time series voltage values of propulsion battery 105, battery modules 115, and batteries/battery units as necessary or desired.

One way that voltage sensors may be used to detect possible LVE is to monitor for a particular pattern indicative of LVE in the particular implementation and may make use of historical voltage levels stored by controller 125. For example, should the voltage sensors detect a voltage drop of contiguous series elements relative to unaffected series elements and relative to expected voltage drop. This voltage drop is indicative of an internal current loop. Depending on pack geometry, certain series elements are much more likely to be the terminal elements of an electrolysis short circuit than others. For example, in a pack configuration having a plurality of series-connected modules (each module including series connected cells) where every x^{th} modue (e.g., every fifth module) is proximate to other modules at differing potentials, the electrolysis reaction will bridge between these modules. A detection process can be particularly sensitive to contiguous voltage drops bookended by these series elements to more positively identify an internal short as an electrolysis phenomenon. Other patterns may be appropriate in this or other contexts.

CURRENT—Sensor system 130 may include one or more current sensors. Battery modules 115 are coupled in series to store and produce the energy of propulsion battery 105. Additionally, it is common for the modules themselves to include series-connected batteries or other battery unit. The current sensors are placed in enclosure 110 to measure real-time series current values of propulsion battery 105, battery modules 115, and batteries/battery units as necessary or desired.

One way that current sensors may be used to detect possible LVE is to monitor for a particular pattern indicative of LVE in the particular implementation. For example, should the current sensors detect a reading higher than a reading at the pack terminals it may indicate an internal current loop possibly caused by electrolysis.

Another way that current sensors may be used to detect possible LVE is to monitor for an increase in self-discharge rate of a contiguous series of elements relative to an unaffected series of elements and relative to the expected self-discharge rate. The increase in self-discharge rate is indicative of an internal current loop. As in the voltage sensor case based upon pack geometry, certain series elements are much more likely to be the terminal elements of an electrolysis short circuit than others. Some such implementations will be sensitive to a lower current electrolysis reactions than the geometry-based voltage detection, but may require an analysis of data over a longer period of time, likely hours or days.

Other patterns may be appropriate in this or other contexts.

COOLANT FLOW RATE—Sensor system 130 may include one or more coolant flow rate sensors. The cooling system recirculates coolant through enclosure 110 while isolating the coolant from coming into contact with the energy surfaces of propulsion battery 105. The coolant flow rate sensors are placed in a coolant flow path into, through, and out of enclosure 110 to measure an entering coolant flow rate and an exiting coolant flow rate.

One way that coolant flow rate sensors may be used to detect possible LVE is to monitor for a particular pattern indicative of LVE in the particular implementation. For example, should the coolant flow rate sensors detect that more coolant is flowing into enclosure 110 than is flowing out, it may indicate a leak of coolant into enclosure 110 that increases a risk of electrolysis. Other patterns may be appropriate in this or other contexts.

IMMERSION—Sensor system 130 may include one or more immersion sensors. When enclosure 110 is sealed to prevent/inhibit ingress/egress of fluid, strategically positioned immersion sensors are placed inside such an enclosure. A particular pattern of fluid accumulation may indicate LVE or a condition where LVE may occur. In some cases, the design of one or more of the enclosure, battery modules, and coolant system is adapted to improve detection using immersion sensors, or to enable fewer sensors to be used.

One way that immersion sensors may be used to detect possible LVE is to monitor for a particular pattern indicative of LVE in the particular implementation. For example, should the immersion sensors detect fluid accumulation within enclosure 110, a risk of electrolysis is increased. Other patterns may be appropriate in this or other contexts.

As noted herein, some implementations may use one or more of the sensors disclosed herein. Some of the implementations detect LVE with a high probability of accuracy while others detect possible LVE. Temperature sensors and other types of sensors as described in the incorporated HVE application are also preferably included but may not, directly, indicate LVE. In some cases, identification of electrolysis that is not HVE means, in the present context, HVE. Because of the HVE associated urgencies mentioned herein and in the incorporated patent applications, the preferred embodiments focus on testing/evaluating HVE. And thus one LVE “detection” modality is to eliminate HVE as the type of electrolysis, leaving LVE. Proper selection and use of one or more different types of sensors increases the data from which highly accurate predictions are made. For example, a small change in flowrate with a current short circuit implicating low voltage elements in an area where fluid could accumulate without significant local temperature increases a likelihood of LVE as opposed to HVE. On the other hand, the same situation having an increased localized temperature increase increases a likelihood of HVE as opposed to LVE. Different implementations may have differing metrics and patterns appropriate to the specifics of the design.

II. Remediation Response

The preferred embodiments include process and apparatus that are useful to respond to a detected or possible low voltage electrolysis reaction. The preferred responses include one or both of stopping the energy driving the LVE and lowering the boiling point of the electrolyzing coolant.

Coolant Removal

Remediation system 135 includes a mechanism to remove coolant from flowing into enclosure 110 to minimize coolant available for low voltage electrolysis. Controller 125 deactivates pumps of the cooling system to stop additional coolant flow when this remediation response is active.

Flammable Gas Removal

Remediation system 135 includes a mechanism to actively remove flammable gas out of enclosure 110. Often enclosure 110 is hermetically sealed, and sometimes there are one-way pressure relief valves to reduce risks of over-pressurization. Removing any detected flammable gas, such as by using one or more fans and a controllable valve disposed in an exterior wall of enclosure 110, dramatically reduces or eliminates hazards associated with flammable gas from low voltage electrolysis.

Oxygen Displacement

Remediation system 135 includes a mechanism to actively displace oxygen out of enclosure 110. Often enclosure 110 is hermetically sealed therefore it is possible to use one or more strategically placed purge valves to introduce an inert gas inside enclosure and thus remove oxygen. Removing oxygen from enclosure 110 means that even high concentrations of hydrogen gas cannot combust or explode, dramatically reducing or eliminating hazards associated with flammable gas from low voltage electrolysis.

Flammable Gas Displacement

Remediation system 135 includes a mechanism to actively displace hydrogen out of enclosure 110. Often enclosure 110 is hermetically sealed therefore it is possible to use one or more strategically placed purge valves to introduce an inert gas inside enclosure and thus remove hydrogen. Removing hydrogen from enclosure 110 reduces concentrations of the hydrogen gas and it will not combust or explode, dramatically reducing or eliminating hazards associated with flammable gas from low voltage electrolysis. Flammable gas displacement can occur separate from, or in cooperation with, oxygen displacement described herein.

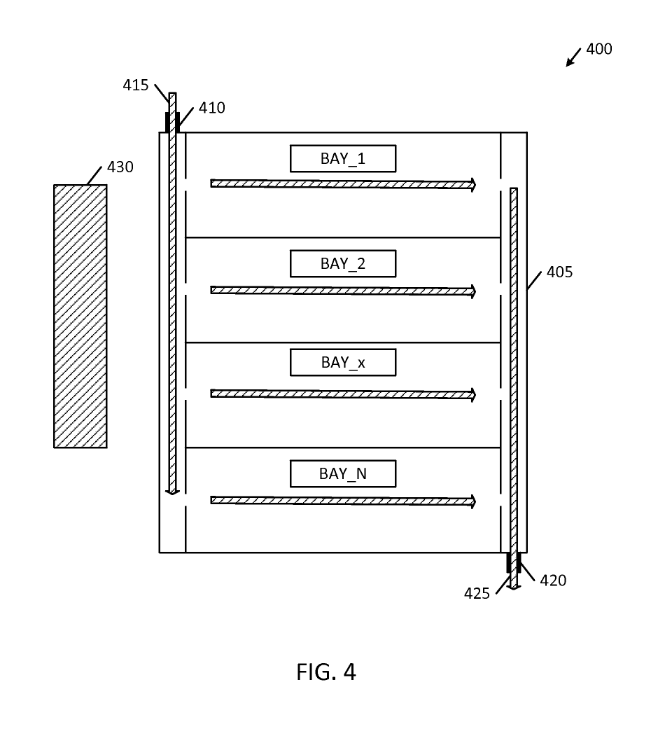

FIG. 4 illustrates a purge system 400 for displacement of oxygen within a battery pack enclosure 405. Preferably enclosure 405 is specifically arranged with an inlet port 410 for introduction of a stream of an inert gas 415 and one or more outlet ports 420 for exhaust of enclosure gas 425. Inlet port 410 is preferably located opposite of one or more ports 420 to minimize recirculation and dead zone within enclosure 405. Such placement helps to maximize displacement of the enclosure gas (which includes oxygen) with the incoming inert gas (e.g., nitrogen). A gas reservoir 430 stores a suitable volume of the inert gas, such as in a compressed gas tank, and is coupled to inlet port 410 when oxygen displacement is desired. Air passages within enclosure 405 are preferably designed and arranged to facilitate an optimum air flow within enclosure 405 to displace oxygen by the introduced inert gas.

Preservice Handling

Enclosure 405 is designed for service by qualified technicians at authorized service facilities. It can be hazardous to these technicians to open enclosure 405 to initiate service when there is hydrogen gas contained within. Purge system 400 is used for pres-service purging of any flammable gas and/or displacement of oxygen from within enclosure 405. Hydrogen gas concentration of exhaust gas 425 is monitored as inert gas is streamed into inlet port 410 until the concentration is deemed low enough to be safe (e.g., <0.5% hydrogen concentration by volume). Preferably exhaust gas 425 is routed, sequestered, and safely stored as the inert gas is streamed to reduce risks from the hydrogen gas as it is displaced from enclosure 405.

Note that the general arrangement of FIG. 4 may be adapted for both the oxygen displacement and the hydrogen displacement models. In some arrangements, it may be possible to displace significant quantities of oxygen while hydrogen remains (particularly if the LVE continues to generate hydrogen gas, and often LVE generates oxygen gas as well) while in others all the enclosure gas, including oxygen and hydrogen, are displaced, particularly when LVE has stopped. The two described embodiments associated with FIG. 4 include these implementations.

The systems and methods are preferably implemented using a microprocessor executing program instructions from a memory, the instructions causing the apparatus to perform as described herein.

The system and methods above has been described in general terms as an aid to understanding details of preferred embodiments of the present invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A detection system for low voltage electrolysis in a battery pack, comprising:
an enclosure including a plurality of electrically-coupled battery modules storing energy for the battery pack;
a sensor system, coupled to said enclosure, configured to collect a plurality of data from said enclosure; and
a controller, coupled to said sensor system, configured to evaluate said plurality of data against one or more predetermined patterns associated with a possible low voltage electrolysis of fluid inside said enclosure that generates a flammable gas, with said controller configured to indicate said possible low voltage electrolysis occurring within said enclosure when said plurality of data has a predetermined relationship to said one or more predetermined patterns.

2. The detection system of claim 1 wherein said enclosure further includes a coolant distribution system disposed among and electrically isolated from said plurality of battery modules; and wherein said coolant distribution system uses a coolant solution that releases hydrogen gas when electrolyzed using a voltage potential of about 5 volts or more.

3. The detection system of claim 1 wherein said sensor system includes a hydrogen gas sensor and wherein said one or more patterns includes a non-zero concentration of hydrogen gas within said enclosure.

4. The detection system of claim 1 wherein each said battery module includes a plurality of series-connected energy storage elements with each element having a voltage drop and wherein said sensor system includes a plurality of voltage sensors coupled to said plurality of elements and wherein said one or more patterns includes an anomalous voltage drop for a set of one or more of said elements indicating an internal short-circuit.

5. The detection system of claim 4 wherein said set of one or more elements include physically adjacent elements from different battery modules.

6. The detection system of claim 1 wherein each said battery module includes a plurality of series-connected energy storage elements and wherein said sensor system includes a plurality of current sensors for one or more of said elements and a current sensor for terminals of the battery pack and wherein said one or more patterns includes a current sensor reading for one or more of said elements than for a current sensor reading for said battery pack.

7. The detection system of claim 1 wherein said sensor system includes an immersion sensor measuring an accumulation of a fluid within said enclosure and wherein said one or more patterns includes detection of a non-zero value from said immersion sensor.

8. The detection system of claim 1 wherein said sensor system includes a first coolant flow rate sensor for an in-flow rate of coolant into said enclosure and a second coolant flow rate sensor for an out-flow rate of coolant out of said enclosure and wherein said one or more patterns includes said in-flow rate exceeding said out-flow rate.

9. A method for detecting a low voltage electrolysis in a battery pack, the method comprising the steps of:
a) collecting a plurality of data from a sensor system measuring data from an enclosure, said enclosure including a plurality of electrically-coupled battery modules storing energy for the battery pack;
b) evaluating, using a controller, said plurality of data against one or more predetermined patterns associated with a possible low voltage electrolysis of fluid inside said enclosure that generates a flammable gas, with said controller indicating said possible low voltage electrolysis occurring within said enclosure when said plurality of data has a predetermined relationship to said one or more predetermined patterns.

10. The detecting method of claim 9 wherein said enclosure further includes a coolant distribution system disposed among and electrically isolated from said plurality of battery modules and wherein said coolant distribution system uses a coolant solution that releases hydrogen gas when electrolyzed using a voltage potential of about 5 volts or more.

11. The detecting method of claim 9 wherein said sensor system includes a hydrogen gas sensor and wherein said one or more patterns includes a non-zero concentration of hydrogen gas within said enclosure.

12. The detecting method of claim 9 wherein each said battery module includes a plurality of series-connected energy storage elements with each element having a voltage drop and wherein said sensor system includes a plurality of voltage sensors coupled to said plurality of elements and wherein said one or more patterns includes an anomalous voltage drop for a set of one or more of said elements indicating an internal short-circuit.

13. The detecting method of claim 12 wherein said set of one or more elements include physically adjacent elements from different battery modules.

14. The detecting method of claim 9 wherein each said battery module includes a plurality of series-connected energy storage elements and wherein said sensor system includes a plurality of current sensors for one or more of said elements and a current sensor for terminals of the battery pack and wherein said one or more patterns includes a current sensor reading for one or more of said elements than for a current sensor reading for said battery pack.

15. The detecting method of claim 9 wherein said sensor system includes an immersion sensor measuring an accumulation of a fluid within said enclosure and wherein said one or more patterns includes detection of a non-zero value from said immersion sensor.

16. The detecting method of claim 10 wherein said sensor system includes a first coolant flow rate sensor for an in-flow rate of said coolant solution into said enclosure and a second coolant flow rate sensor for an out-flow rate of said coolant solution out of said enclosure and wherein said one or more patterns includes said in-flow rate exceeding said out-flow rate.
